(19) United States
(12) Patent Application Publication
(10) Pub. No.: US 2023/0229704 A1
(43) Pub. Date: Jul. 20, 2023

(54) GRAPH PROCESSING METHOD AND APPARATUS

(71) Applicant: HUAWEI TECHNOLOGIES CO.,LTD., Shenzhen (CN)

(72) Inventors: Zhiyong WANG, Hangzhou (CN); Rusheng PAN, Hangzhou (CN); Yating WEI, Hangzhou (CN); Wei CHEN, Hangzhou (CN); Han GAO, Hong Kong (CN)

(21) Appl. No.: 18/186,267

(22) Filed: Mar. 20, 2023

Related U.S. Application Data
(63) Continuation of application No. PCT/CN2021/096023, filed on May 26, 2021.

(30) Foreign Application Priority Data
Sep. 21, 2020 (CN) 202010998184.0

(51) Int. Cl. G06F 16/901

(52) U.S. Cl. CPC G06F 16/9024

(57) ABSTRACT

A graph processing method and apparatus are used in the field of data visualization. In this method, first, at least two subgraphs of a first graph are obtained, where each subgraph includes, in the first graph, a plurality of nodes and edges between the nodes; second, the nodes and the edges that are included in each subgraph of the at least two subgraphs are calculated, to calculate respective identifiers of the at least two subgraphs; and third, subgraphs with a same identifier in the at least two subgraphs are combined to generate a second graph; and then the second graph generated through combination is output.

This application is a continuation of International Application No. PCT/CN2021/096023, filed on May 26, 2021, which application claims priority to Chinese Patent Application No. 202010998184.0, filed on Sep. 21, 2020. The disclosures of the aforementioned applications are hereby incorporated by reference in their entireties.

### TECHNICAL FIELD

Embodiments of this application relate to the field of data visualization, and in particular, to a graph processing method and apparatus, and a device.

### BACKGROUND

Deep learning technologies are widely used in feature extraction, inference, and prediction of complex data, including data types such as a graph, text, and voice. In an implementation, users usually use a deep learning framework to write code for data preprocessing, model building, model training, model evaluation and deployment, and the like. Further, refer to FIG. 1. FIG. 1 is a schematic diagram of an embodiment of a computational graph according to an embodiment of this application. As shown in the figure, a deep learning framework may indicate a machine to perform model training and inference in a form of a computational graph. However, complexity of the deep learning framework and a model sets a high threshold for the users for use, and it is especially difficult for the users to quickly locate a problem and debug the model.

Currently, visualizing the computational graph generated by the deep learning framework can help the users check whether the code written by the users complies with a desired model structure, and locate the problem in a model training process.

However, because a graph usually includes a hierarchical clustered scope, and nodes and edges that have a large amount of data, the nodes and edges in the graph are arranged disorderly. This reduces graph processing efficiency, and therefore reduces clarity and integrity of a data flow direction in the graph displayed by a terminal device.

### SUMMARY

Embodiments of this application provide a graph processing method and apparatus, to improve clarity and integrity of a data flow direction in a graph without affecting a structure of the graph and expressed computational logic of the graph.

According to a first aspect, embodiments of this application provide a graph processing method, including that: because a first graph generated by a complex deep learning model usually includes a frequent subgraph, and the frequent subgraph is a subgraph structure that repeatedly appears in one graph structure, if the first graph including the frequent subgraph is displayed on a terminal device, efficiency of processing the first graph by the terminal device is reduced, and in addition, it is also unfavorable for users to quickly find a key sub-region. Therefore, the graph processing apparatus determines that, in the first graph, a node whose outdegree is greater than a second threshold is a start node; then determines a corresponding end node by using a path through which a data flow of the start node passes; and determines all subgraphs between two nodes by using the start node and the end node, where each subgraph includes edges and nodes, and the edges indicate a data flow direction between different nodes. The second threshold indicates an outdegree of a data flow direction of nodes. That is, an outdegree of a node being greater than the second threshold indicates that the outdegree of the node already exceeds a preset outdegree, so that there are more data flow directions of the node, and therefore, there are more edges displayed in the graph. In addition, a specific value of the second threshold may be 2, 5, 8, or the like. Specific data of the second threshold needs to be determined in advance according to an actual situation in the first graph. This is not limited herein. Then, the graph processing apparatus calculates respective identifiers of the at least two subgraphs based on nodes and edges that are included in each subgraph of at least two subgraphs. The identifiers indicate features of the subgraphs, or the identifiers are hash values of the subgraphs. This is not specifically limited herein. Further, because the identifiers of the subgraphs are the same, that is, it indicates that the subgraphs have similar features, the graph processing apparatus combines subgraphs with a same identifier in the at least two subgraphs, to generate and output a second graph. For example, when the method in this embodiment of this application is applied to a terminal device, the terminal device may read, from a memory of the terminal device, the first graph stored in the deep learning framework, or receive the first graph sent by a server, and then directly display the second graph generated in the foregoing manner. In addition, when the method in this embodiment of this application is applied to the server, the server may read, from a memory of the server, the stored first graph, and send, after the second graph is generated in the foregoing manner, the second graph to the terminal device, so that the terminal device can display the received second graph.

In this implementation, based on the obtained first graph, a subgraph that has a corresponding identifier is determined, and at least two subgraphs with a same identifier are combined to generate the second graph. Therefore, a quantity of nodes and a quantity of edges that are included in the second graph are reduced, thereby improving graph processing efficiency. Because subgraphs with a same identifier are similar, the combination does not affect a structure of the graph and expressed computational logic of the graph, and clarity and integrity of a data flow direction in the graph can also be improved.

In an implementation of this embodiment of this application, the identifier is a hash value. In this embodiment, a computational graph corresponding to the deep learning framework is used as an example. Based on a feature of a deep learning computational graph, a hash value corresponding to a node may indicate a feature of the node, a hash value corresponding to an edge may indicate a feature of the edge, and nodes and edges with different features may be distinguished by using the hash values. Therefore, for each subgraph of the at least two subgraphs, based on the hash value corresponding to the node in each subgraph and the hash value corresponding to the edge in each subgraph, the hash value corresponding to each subgraph is calculated, and the obtained hash value corresponding to the subgraph may further distinguish subgraphs with different features.

In this implementation, based on the hash value corresponding to the node in each subgraph and the hash value corresponding to the edge in each subgraph, the hash value corresponding to the subgraph that is obtained through calculation can accurately reflect the feature of the subgraph, thereby subsequently ensuring accuracy of combining subgraphs that have a same hash value. Therefore, accuracy of graph processing is further improved.

In an implementation of this embodiment of this application, the identifier is a hash value. Therefore, in each subgraph, a hash value corresponding to a node is related to an attribute of the node, in other words, the hash value corresponding to the node is obtained by performing calculation on the attribute of the node in each subgraph. Specifically, a node in the subgraph corresponds to a plurality of types of node attributes. A node attribute corresponding to the node includes, but is not limited to, a variable type, a parameter type, a scope to which the node belongs, and the like. The node attribute may reflect a feature of the node. Therefore, a hash value corresponding to the node obtained by calculating the node attribute may indicate the feature of the node. In addition, in each subgraph, a hash value corresponding to one edge is related to a connection relationship indicated by the edge in each subgraph, that is, the hash value corresponding to the edge in each subgraph is obtained by calculating a connection relationship that is between nodes and that is indicated by the edge in each subgraph, and the connection relationship between the nodes is directional. Specifically, an edge represents a data flow direction from one node to another node. For example, for an edge i, a node from which data is output is a node A, and a node into which data is input is a node B. Therefore, the node A and the node B may be encoded into a character string “[source type]->[target type]”, where [source type] indicates a type of the node A of the edge, and [target type] indicates a type of the node B of the edge. The character string indicates that a data flow direction of the edge i is from the node A to the node B, to ensure a data order. Therefore, a hash value is calculated for the character string, that is, a feature of the edge may be indicated.

In this implementation, because the node attribute may reflect a feature of the node, calculating the attribute of the node to obtain the hash value corresponding to the node can improve accuracy of the obtained hash value corresponding to the node. In addition, the connection relationship indicated by using the edge is directional, so that the hash value through calculation is more accurate. Therefore, the hash value corresponding to the subgraph may be more accurate, thereby further improving accuracy of graph processing.

In an implementation of this embodiment of this application, the identifier is a hash value. In this embodiment, a computational graph corresponding to the deep learning framework is used as an example. Based on a feature of a deep learning computational graph, subgraphs that have a same hash value in the at least two subgraphs may be combined to reduce a quantity of nodes and a quantity of edges that are included in the computational graph, a node whose outdegree or indegree is greater than a first threshold in the first graph can be determined as the first node, and then a first port and a second port are allocated to the first node. The first port is a port, of each first node, through which an edge indicating that data is input into each first node passes, and the second port is a port, of each first node, through which an edge indicating that data is output from each first node passes. Based on all edges that are included in the graph generated through combination, a plurality of edges that pass through one first port are combined, and a plurality of edges that pass through one second port are combined, so as to generate a second graph. The first threshold may indicate an outdegree of a data flow direction of the node, or may indicate an indegree of data inflow of the node. That is, an outdegree of a node being greater than the first threshold indicates that the outdegree of the node exceeds a preset outdegree, or an indegree of a node being greater than the first threshold indicates that the indegree of the node exceeds a preset indegree, which both indicate a relatively large quantity of data flow directions of the node. Therefore, there are a relatively large quantity of edges shown in the figure. In addition, a specific value of the first threshold may be 3, 5, 4, or the like, and specific data of the first threshold needs to be predetermined according to an actual situation of the computational graph. This is not limited herein.

In this implementation, because the first node is a node whose outdegree or indegree is greater than the first threshold, there are a relatively large quantity of data flow directions in which data is output or input into or from the first node. The first port and the second port are allocated to the first node. Edges that indicate a data input and that pass through the first port are combined with edges that indicate a data output and that pass through the second port, to generate the second graph, thereby further improving clarity of the data flow directions, in the graph, that are displayed by the terminal device.

In an implementation of this embodiment of this application, the identifier is a hash value, and the second graph is arranged in an orthogonal edge routing manner. Specifically, based on the first port and the second port, a port constraint (port constraint) optimized arrangement algorithm is first used to perform constraint optimization on locations and sequences of the first port and the second port with an overall orthogonal edge routing arrangement as a target, to obtain location coordinates of the first port and the second port through calculation, so that the orthogonal edge routing arrangement is completed and the second graph is generated. The orthogonal arrangement is specifically that an included angle of connection lines around the node is 90 degrees, and the edge routing is an arrangement and directions of specific connection lines in the figure.

In this implementation, constraint optimization can be performed on locations and sequences of the first port and the second port by using the orthogonal edge routing manner for arrangement, so that an overall data flow direction from left to right is complete and clear, thereby further improving clarity of the data flow direction displayed by the terminal device in the graph.

In an implementation of this embodiment of this application, the identifier is a hash value. In this embodiment, a computational graph corresponding to the deep learning framework is used as an example. Based on a feature of a deep learning computational graph, subgraphs that have a same hash value in the at least two subgraphs may be combined to reduce a quantity of nodes and a quantity of edges that are included in the computational graph. When the obtained graph includes a scope, because the scope indicates a computational function by using a combination of one group of nodes and edges, an edge indicating an input of the scope may be determined as a first edge, and an edge indicating an output of the scope may be determined as a second edge. Then, ports are added to a plurality of first edges and a plurality of second edges, and a port on an edge that is in the plurality of first edges, that corresponds to one scope, and that indicates an input from a same node is determined as a third port. A plurality of third ports are combined. In addition, a port on an edge that is in the plurality of second edges, that corresponds to one scope, and that indicates an output toward a same node is determined as a fourth port, and a plurality of fourth ports are combined. Based on a combined port, the second graph is generated in an orthogonal edge routing manner. A specific orthogonal edge routing manner is similar to that described in the foregoing embodiments of this application, and details are not described herein again.

In this implementation, first, at least two subgraphs that have a same hash value are combined to reduce a quantity of nodes and a quantity of edges that are included in the second graph, thereby improving graph processing efficiency. Because the subgraphs that have a same hash value are similar, the combination does not affect a data flow direction in the graph, thereby further improving clarity and integrity of the data flow direction displayed by the terminal device in the graph. Second, ports that belong to one scope and that are on an edge indicating an input from a same node are combined, and ports that belong to one scope and that are on an edge indicating an output toward a same node are combined, so that a combined port can separate the outside of the scope from the inside of the scope. Because there are interlocking and complex edges between each scope, the outside and the inside of the scope are separately arranged by using the combined port, so that clarity of the data flow direction displayed in the graph can be further improved.

In an implementation of this embodiment of this application, the identifier is a hash value. In this embodiment, a computational graph corresponding to the deep learning framework is used as an example. Based on a feature of a deep learning computational graph, subgraphs that have a same hash value in the at least two subgraphs may be combined to reduce a quantity of nodes and a quantity of edges that are included in the computational graph, a node whose outdegree or indegree is greater than a first threshold in the first graph can be determined as a first node, and then a first port and a second port are allocated to the first node. The first port is a port, of each first node, through which an edge indicating that data is input into each first node passes, and the second port is a port, of each first node, through which an edge indicating that data is output from each first node passes. Based on all edges that are included in the graph generated through combination, a plurality of edges that pass through one first port are combined, and a plurality of edges that pass through one second port are combined, so as to generate the second graph. The first threshold may indicate an outdegree of a data flow direction of the node, or may indicate an indegree of data inflow of the node. That is, an outdegree of a node being greater than the first threshold indicates that the outdegree of the node exceeds a preset outdegree, or an indegree of a node being greater than the threshold indicates that the indegree of the node exceeds a preset indegree, which both indicate a relatively large quantity of data flow directions of the node. Therefore, there are a relatively large quantity of edges shown in the figure. In addition, a specific value of the first threshold may be 3, 5, 4, or the like, and specific data of the first threshold needs to be predetermined according to an actual situation of the computational graph. This is not limited herein. Further, when the obtained graph includes a scope, because the scope indicates a computational function by using a combination of one group of nodes and edges, an edge indicating an input of the scope may be determined as a first edge, and an edge indicating an output of the scope may be determined as a second edge. Then, ports are added to a plurality of first edges and a plurality of second edges, and a port on an edge that is in the plurality of first edge, that corresponds to one scope, and that indicates an input from a same node is determined as a third port. A plurality of third ports are combined. In addition, a port on an edge that is in the plurality of second edges, that corresponds to one scope, and that indicates an output toward a same node is determined as a fourth port, and a plurality of fourth ports are combined. Based on a combined port, the second graph is generated in an orthogonal edge routing manner. A specific orthogonal edge routing manner is similar to that described in the foregoing embodiments of this application, and details are not described herein again.

In this implementation, first, at least two subgraphs that have a same hash value are combined to reduce a quantity of nodes and a quantity of edges that are included in the second graph, thereby improving graph processing efficiency. Because the subgraphs that have a same hash value are similar, the combination does not affect a structure of the graph, expressed computational logic of the graph, and clarity and integrity of a data flow direction in the graph. Second, because the first node is a node whose outdegree or indegree is greater than the first threshold, there are a relatively large quantity of data flow directions in which data is output or input from or into the first node. The first port and the second port are allocated to the first node. Edges that indicate a data input and that pass through the first port are combined with edges that indicate a data output and that pass through the second port, thereby further improving clarity of the data flow directions, in the graph, that are displayed by the terminal device. Third, ports that belong to one scope and that are on edges that indicate an input from a same node are combined, and ports that belong to one scope and that are on edges that indicate an output toward a same node are combined, so that a combined port can separate the outside of the scope from the inside of the scope. Because there are interlocking and complex edges between each scope, the outside and the inside of the scope are separately arranged by using the combined port, so that clarity of the data flow direction displayed in the graph can be further improved.

According to a second aspect, embodiments of this application provide a graph processing apparatus. The graph processing apparatus includes: an obtaining module, configured to obtain at least two subgraphs of a first graph, where each subgraph includes, in the first graph, a plurality of nodes and edges between the nodes; a computational module, configured to calculate respective identifiers of the at least two subgraphs based on the nodes and the edges that are included in each subgraph of the at least two subgraphs; a combining module, configured to combine subgraphs with a same identifier in the at least two subgraphs; and an output module, configured to output a second graph generated through combination.

In an implementation of embodiments of this application, the identifier is a hash value, and data of each subgraph indicates nodes and edges in each subgraph. The computational module is specifically configured to, for each subgraph of the at least two subgraphs, calculate, based on hash values respectively corresponding to the plurality of nodes in each subgraph and hash values corresponding to the plurality of edges in each subgraph, a hash value corresponding to each subgraph.

In an implementation of embodiments of this application, in each subgraph, a hash value corresponding to one node is related to an attribute of the node, and in each subgraph, a hash value corresponding to one edge is related to a connection relationship indicated by the edge in each subgraph.

In an implementation of embodiments of this application, the identifier is a hash value. The combining module is specifically configured to combine subgraphs, of the at least two subgraphs, that have a same hash value; and add a first port and a second port of each first node in a plurality of first nodes. Each first node is a node whose outdegree or indegree is greater than a first threshold in the first graph. An edge indicating that data is input into each first node passes through the first port of each first node, and an edge indicating that data is output from each first node passes through the second port of each first node. The following operations are performed on the plurality of first nodes to generate the second graph: combining a plurality of edges that pass through one first port; and combining a plurality of edges that pass through one second port.

In an implementation of embodiments of this application, the second graph is arranged in an orthogonal edge routing manner.

In an implementation of embodiments of this application, the identifier is a hash value. The combining module is specifically configured to: combine subgraphs, of the two subgraphs, that have a same hash value; add ports to a plurality of first edges and a plurality of second edges, where each first edge indicates an input of a scope, each second edge indicates an output of the scope, and the scope indicates a computational function by using a combination of one group of nodes and edges; combine a plurality of third ports in the plurality of added ports, where the third port is a port on an edge that is in the plurality of first edges, that corresponds to one scope, and that indicates an input from a same node; and combine a plurality of fourth ports in the plurality of added ports, where the fourth port is a port on an edge that is in the plurality of second edges, that corresponds to one scope, and that indicates an output toward a same node; and arrange, based on the combined port, the second graph in an orthogonal edge routing manner.

In an implementation of embodiments of this application, the identifier is a hash value. The combining module is specifically configured to: combine subgraphs, of the at least two subgraphs, that have a same hash value; add a first port and a second port of each first node in a plurality of first nodes, where each first node is a node whose outdegree or indegree is greater than a first threshold in the first graph, an edge indicating that data is input into each first node passes through the first port of each first node, and an edge indicating that data is output from each first node passes through the second port of each first node; combine a plurality of edges that pass through one first port, and combine a plurality of edges that pass through one second port; add ports to a plurality of first edges and a plurality of second edges, where each first edge indicates an input of a scope, each second edge indicates an output of the scope, and the scope indicates a computational function by using a combination of one group of nodes and edges; combine a plurality of third ports in the plurality of added ports, where the third port is a port on an edge that is in the plurality of first edges, that corresponds to one scope, and that indicates an input from a same node, and combine a plurality of fourth ports in the plurality of added ports, where the fourth port is a port on an edge that is in the plurality of second edges, that corresponds to one scope, and that indicates an output toward a same node; and arrange, based on a result of one or more of the foregoing combination steps, the second graph in an orthogonal edge routing manner.

According to a third aspect of embodiments of this application, a terminal device is provided. The terminal device may be the graph processing apparatus in the foregoing method design, or a chip disposed in the graph processing apparatus. The terminal device includes a processor that is coupled to a memory, and may be configured to execute instructions in the memory, so as to implement the method performed by the graph processing apparatus in the first aspect and in any one of the possible implementations thereof. Optionally, the terminal device further includes a memory. Optionally, the terminal device further includes a communications interface, and the processor is coupled to the communications interface.

When the terminal device is a graph processing apparatus, the communications interface may be a transceiver or an input/output interface.

When the terminal device is a chip disposed in the graph processing apparatus, the communications interface may be an input/output interface.

Optionally, the transceiver may be a transceiver circuit. Optionally, the input/output interface may be an input/output circuit.

According to a fourth aspect of embodiments of this application, a server is provided. The server may be the graph processing apparatus in the foregoing method design, or a chip disposed in the graph processing apparatus. The server includes a processor that is coupled to a memory, and may be configured to execute instructions in the memory, so as to implement the method performed by the graph processing apparatus in the first aspect and any one of the possible implementations thereof. Optionally, the server further includes a memory. Optionally, the server further includes a communications interface, and the processor is coupled to the communications interface.

When the server is a graph processing apparatus, the communications interface may be a transceiver or an input/output interface.

When the server is a chip disposed in the graph processing apparatus, the communications interface may be an input/output interface.

Optionally, the transceiver may be a transceiver circuit. Optionally, the input/output interface may be an input/output circuit.

According to a fifth aspect of embodiments of this application, a program is provided. When the program is executed by a processor, the program is used to perform the method in the first aspect and any one of the possible implementations thereof.

According to a sixth aspect of embodiments of this application, a computer program product (or referred to as a computer program) stored in one or more computers is provided. When the computer program product is executed by a processor, the processor performs the method in the first aspect or any one of the possible implementations thereof.

According to a seventh aspect of embodiments of this application, a chip is provided. The chip includes at least one processor that is configured to support a terminal device in implementing the function in the first aspect or any one of the possible implementations thereof. In a possible design, the chip system may further include a memory. The at least one processor is communicatively connected to the at least one memory, and the at least one memory stores instructions that are used to store a program instruction and data that are necessary for the terminal device and a server. Optionally, the chip system further includes an interface circuit, and the interface circuit provides the program instruction and/or the data for the at least one processor.

According to an eighth aspect of embodiments of this application, a computer readable storage medium is provided. The computer readable storage medium stores a program, and the program enables a terminal device to perform the method in the first aspect and any one of the possible implementations thereof.

It should be noted that for beneficial effects brought by the implementations of the second aspect to the eighth aspect of this application and descriptions of the implementations of the aspects, refer to the implementations of the first aspect for understanding. Therefore, details are not described again.

According to the technical solutions provided in this application, at least two subgraphs of a first graph may be obtained. Based on nodes and edges that are included in each of the at least two subgraphs, hash values of the at least two subgraphs are calculated. Subgraphs, of the at least two subgraphs, that have a same hash value are combined to generate and output a second graph. In this way, a quantity of nodes and a quantity of edges that are included in the second graph are reduced, thereby improving graph processing efficiency. In addition, because the combination does not affect a structure of the graph and expressed computational logic of the graph, clarity and integrity of a data flow direction in the graph can also be improved.

### BRIEF DESCRIPTION OF DRAWINGS

FIG. 1 is a schematic diagram of an embodiment of a computational graph according to an embodiment of this application;

FIG. 2 is a schematic diagram of a system architecture according to an embodiment of this application;

FIG. 3 is a schematic diagram of an architecture for product implementation according to an embodiment of this application;

FIG. 4 is a schematic diagram of an embodiment of a node according to an embodiment of this application;

FIG. 5 is a schematic diagram of an embodiment of an edge according to an embodiment of this application;

FIG. 6 is a schematic diagram of an embodiment of a frequent subgraph structure according to an embodiment of this application;

FIG. 7 is a schematic diagram of an embodiment of a simple graph and a compound graph according to an embodiment of this application;

FIG. 8 is a schematic diagram of an embodiment of a cross-scope edge according to an embodiment of this application;

FIG. 9 is a schematic diagram of an embodiment of a graph processing method according to an embodiment of this application;

FIG. 10 is a schematic diagram of an embodiment of a computational graph according to an embodiment of this application;

FIG. 11 is a schematic diagram of another embodiment of a graph processing method according to an embodiment of this application;

FIG. 12 is a schematic diagram of another embodiment of a computational graph according to an embodiment of this application;

FIG. 13 is a schematic diagram of an embodiment of a BERT network computational graph according to an embodiment of this application;

FIG. 14 is a schematic diagram of still another embodiment of a graph processing method according to an embodiment of this application;

FIG. 15 is a schematic diagram of an embodiment of a port according to an embodiment of this application;

FIG. 16 is a schematic diagram of an embodiment of combining a port according to an embodiment of this application;

FIG. 17 is a schematic diagram of yet another embodiment of a graph processing method according to an embodiment of this application;

FIG. 18 is a schematic diagram of an embodiment of a graph processing apparatus according to an embodiment of this application; and

FIG. 19 is a schematic diagram of an embodiment of a structure of a graph processing apparatus according to an embodiment of this application.

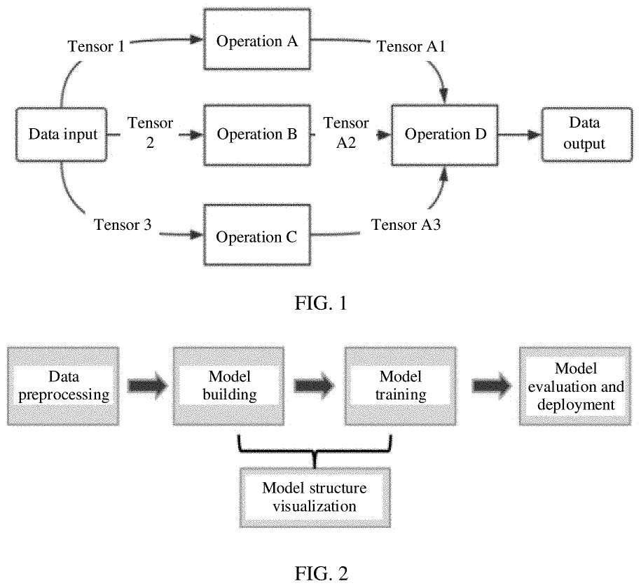

### DESCRIPTION OF EMBODIMENTS

Embodiments of this application provide a graph processing method and apparatus. At least two subgraphs of a first graph may be obtained, where each subgraph includes a plurality of nodes in the first graph and edges between the nodes. Then, a node and an edge that are included in each of the at least two subgraphs are calculated, and respective identifiers of the at least two subgraphs are calculated. Subgraphs with a same identifier in the at least two subgraphs are combined to generate a second graph, and then the second graph generated through combination is output. In this way, a quantity of nodes and a quantity of edges that are included in the second graph are reduced, thereby improving graph processing efficiency. In addition, because the combination does not affect a structure of the graph and expressed computational logic of the graph, clarity and integrity of a data flow direction in the graph can be further improved.

In the specification, claims, and accompanying drawings of this application, terms “first”, “second”, “third”, “fourth”, and the like (if existent) are intended to distinguish between similar objects but do not necessarily indicate a specific order or sequence. It should be understood that the data used in such a way are interchangeable in appropriate circumstances, so that embodiments described herein can be implemented in an order other than the content illustrated or described herein. In addition, terms “include” and “have”, and any variations thereof are intended to cover a non-exclusive inclusion, for example, a process, method, system, product, or device that includes a series of steps or units is not necessarily limited to those clearly listed steps or units, but may include other steps or units that are not clearly listed or inherent to such a process, method, product, or device.

It should be understood that names of all nodes, graphs, and edges in this application are merely names set for ease of description in this application, and the names may be different in actual application. It should not be understood that the names of various nodes, graphs, and edges are limited in this application. Any name that has a same or similar function as the node, graph, and edge used in this application is considered as a method or equivalent replacement in this application, and falls within the protection scope of this application. Details are not described herein again.

To better understand a graph processing method and a related apparatus disclosed in embodiments of this application, the following first describes a system architecture used in embodiments of the present invention. Embodiments of this application may be applied to a module corresponding to model structure visualization. FIG. 2 is a schematic diagram of a system architecture according to an embodiment of this application. As shown in the figure, in a practice of deep learning, for example, in a process of writing code for model building and model training, users can find an existing problem by visualizing a model computational graph. Therefore, a model structure can be accurately and clearly displayed by using the graph processing method provided in embodiments of this application, so that the users can perform debugging and optimization of the training more conveniently.

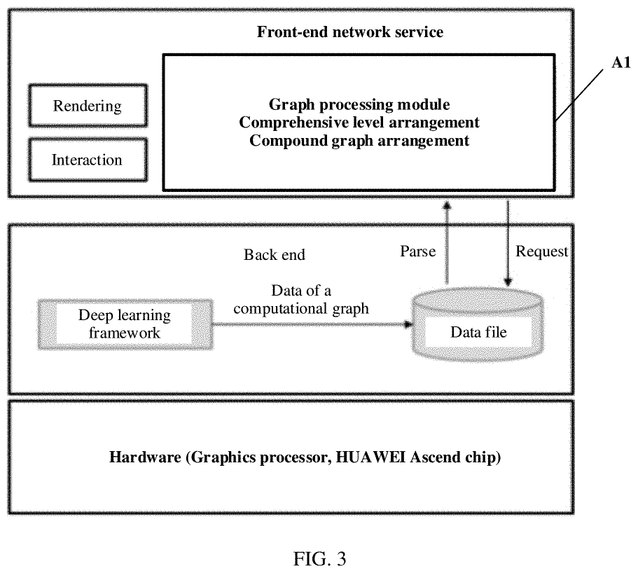

Further, embodiments of this application may be further used as implementation code of a graph processing module in a network (web) service in open source software. FIG. 3 is a schematic diagram of an architecture for product implementation according to an embodiment of this application. A1 indicates the graph processing module. The graph processing module first sends a request, reads initial data of a computational graph in a specific format from a server or a host directory based on the request, and calculates, renders, and displays the initial data of the computational graph in a web service of a browser by using the graph processing method provided in embodiments of this application. Based on the displayed graph data, users can continuously interact with each other and adjust the display form. It should be understood that, in actual application, a unified computational graph data storage and parsing format needs to be configured in advance, and then computational graph processing is performed by using the method provided in this embodiment of this application.

Visualizing the computational graph generated by the deep learning framework can help the users check whether the code written by the users complies with a model structure in their mind, and locate a problem in a model training process. However, a computational graph usually includes a hierarchical clustered scope, and nodes and edges with a large amount of data. Therefore, the nodes and edges in the graph are arranged disorderly, so that graph processing efficiency is reduced, and in the graph, clarity and integrity of a data flow direction displayed by a terminal device are reduced.

The following explains some terms or concepts in embodiments of this application, so as to facilitate understanding by a person skilled in the art.

1. Computational Graph (Computational Graph)

A computational graph is a directed graph that is used to represent a data flow direction and a computational operation. The computational graph includes nodes (node) and edges (edge).

2. Node

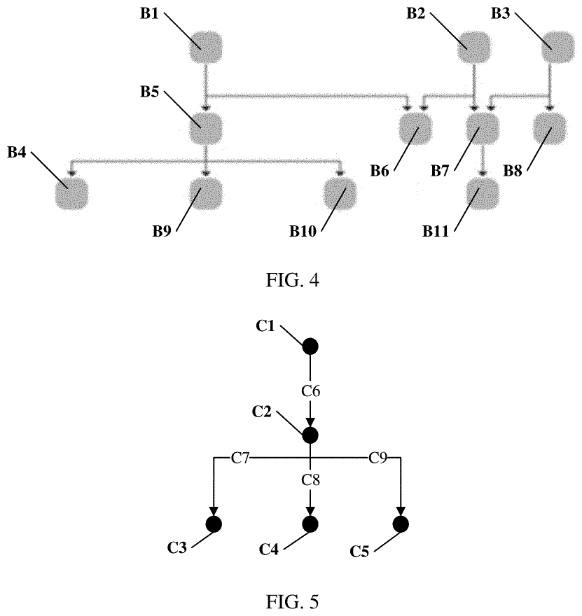

A node in the computational graph corresponds to an operation (Operation) or a variable (Variable). The variable may pass a value of the variable to an operation, and the operation usually indicates computational logic, for example, assignment, addition, rounding, and, or, and the like. Therefore, some nodes in the computational graph define a function of the variable in the computational graph, and a value that is input to the node and a value that is output from the node have a plurality of data forms, for example, a tensor (tensor). The tensor indicates a multi-dimensional array. Therefore, the tensor includes, but is not limited to, a scalar, a vector, a matrix, and a higher order tensor. For ease of understanding, FIG. 4 is a schematic diagram of an embodiment of a node according to an embodiment of this application. As shown in the figure, B1 to B11 all indicate a node.

3. Edge

An edge indicates a data flow direction between nodes in a computational graph. Each end of one edge is connected to a node, and data flows from the node connected to one end of the edge to the node connected to the other end of the edge. Therefore, in a directed graph, an edge has a direction. For example, two ends of one edge are respectively connected to a node A and a node B. A direction of the edge points from the node A to the node B, and data flows from the node A to the node B. For one node, if a direction of one edge points to this node, it indicates that data is input (or “inflow”) into this node. If the direction of the edge points to another node, it indicates that data is output (or “outflow”) from the another node.

In a solution of this application, a port is added to an edge in a process of generating a second graph. The port may be understood as a representation of a data input or output. Therefore, one port may be marked at any position on the edge, for example, one end of the edge (that is, an intersection point of the edge and a node), or for example, a position near one end of the edge.

For ease of understanding, FIG. 5 is a schematic diagram of an embodiment of an edge according to an embodiment of this application. As shown in the figure, C1 to C5 all indicate nodes, and C6 to C9 all indicate edges. An edge C6 is a data flow direction between a node C1 and a node C2. An edge C7 is a data flow direction between the node C2 and a node C3. An edge C8 is a data flow direction between the node C2 and a node C4. An edge C9 is a data flow direction between the node C2 and a node C5. It can be learned that edges have a direction.

4. Frequent Subgraph

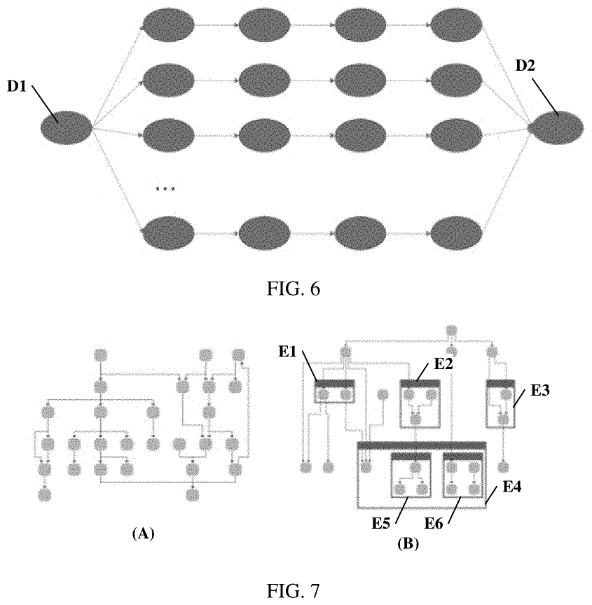

A frequent subgraph is a subgraph structure that repeatedly appears in a computational graph, and the frequent subgraph is a plurality of parallel data flow paths between a start node (startHubNode) and an end node (endHubNode). For ease of understanding, FIG. 6 is a schematic diagram of an embodiment of a frequent subgraph structure according to an embodiment of this application. As shown in the figure, D1 indicates a start node, and D2 indicates an end node. There are a plurality of parallel data flow paths between the start node and the end node. Nodes and edges through which these data flow paths pass constitute a frequent subgraph. The subgraph described in this embodiment is the frequent subgraph described herein.

5. Simple Graph (Simple Graph) and Compound Graph (Compound Graph)

In a visualized interface of a computational graph, if nodes that have a connection relationship belong to a scope (scope) of different levels, the computational graph is referred to as a compound graph, and the scope is a set that includes subnodes. In addition, if there is no scope that is divided by level, the computational graph is referred to as a simple graph. For ease of understanding, FIG. 7 is a schematic diagram of an embodiment of a simple graph and a compound graph according to an embodiment of this application. As shown in the figure, a graph (A) in FIG. 7 indicates a simple graph, a graph (B) in FIG. 7 indicates a compound graph, E1 to E4 indicate scopes, and E5 and E6 indicate subscopes. Specifically, each node in the graph (A) in FIG. 7 does not form a scope, that is, each node does not form a scope relationship of a hierarchical node. While, in the graph (B) in FIG. 7, the scope may include a plurality of subscopes or a plurality of subnodes. For example, a scope E1 includes two subnodes, a scope E2 includes three subnodes, a scope E3 includes two subnodes, and a scope E4 includes one subnode, a sub scope E5, and a sub scope E6. The sub scope E5 includes three subnodes, and the subscope E6 includes four subnodes. A scope relationship of a hierarchical node may be formed by using data flow directions between a plurality of scopes.

6. Cross-Scope Edge

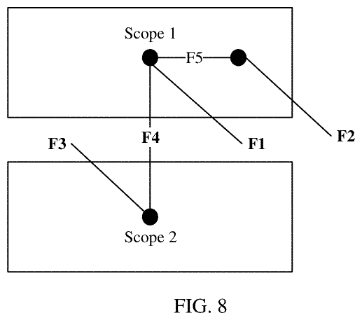

A cross-scope edge is a data flow direction, in a compound graph, between a node inside a scope and a node outside the scope. For ease of understanding, FIG. 8 is a schematic diagram of an embodiment of a cross-scope edge according to an embodiment of this application. As shown in the figure, F1 to F3 indicate nodes, and F4 and F5 indicate edges. A scope 1 and a scope 2 are included in the figure. A scope 1 includes a node F1 and a node F2, and the scope 2 includes a node F3. Because the scope 1 and the scope 2 are different sets, an edge F4 corresponding to a data flow direction between the node F1 and the node F3 is a cross-scope edge. Because the node F1 and the node F2 belong to a same scope, the edge F5 corresponding to a data flow direction between the node F1 and the node F2 is not a cross-scope edge.

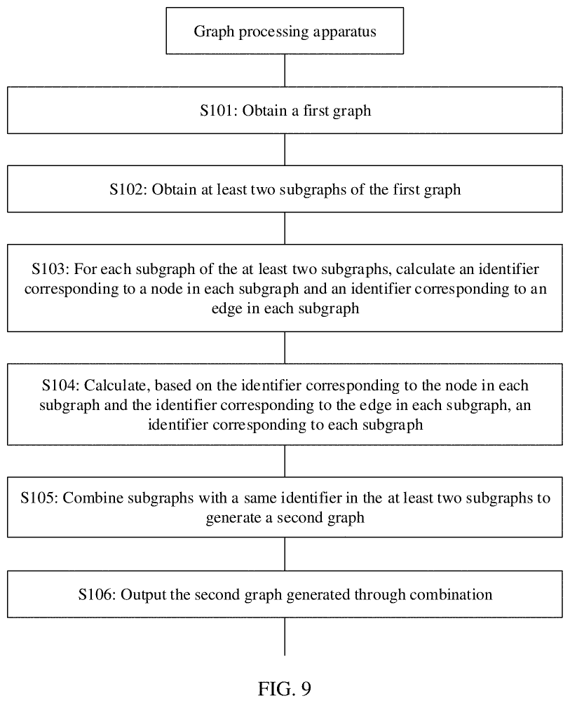

Based on this, to resolve the foregoing problem, an embodiment of this application provides a graph processing method, to improve clarity and integrity, displayed by a terminal device, of a data flow direction in a graph. For ease of understanding, in embodiments of this application, a computational graph corresponding to a deep learning framework is used as an example for description. It should be understood that in actual application, the graph processing method provided in embodiments of this application may be applied to various graphs including nodes and edges. This is not specifically limited herein. The following describes in detail a graph processing method used in an embodiment of this application. FIG. 9 is a schematic diagram of an embodiment of a graph processing method according to an embodiment of this application. As shown in the figure, the graph processing method includes the following steps.

S101: Obtain a first image.

In this embodiment, the graph processing apparatus obtains the first graph. For example, if the graph processing method is applied to a server, that is, the graph processing apparatus is a server, the server may read, from a memory of the server, the first graph (data of computational graph) stored in a deep learning framework. In addition, if the graph processing method is applied to a terminal device, that is, the graph processing apparatus is a terminal device, the terminal device may read, from a memory of the terminal device, the first graph stored in the deep learning framework, or receive the first graph sent by the server. It should be understood that, in actual application, the graph processing apparatus may be a server or a terminal device. A specific graph processing apparatus and a specific manner of obtaining the first graph are not limited in this embodiment. Specifically, the first graph includes edges and nodes, and in this embodiment, an edge indicates a data flow direction between different nodes.

S102: Obtain at least two subgraphs of the first graph.

In this embodiment, because the first graph generated by using a complex deep learning model usually includes a frequent subgraph, if the first graph including a frequent subgraph is displayed on the terminal device, efficiency of processing the first graph by the terminal device is reduced, and in addition, it is also unfavorable for users to quickly find a key sub-region.

Therefore, based on a feature of a deep learning computational graph, the graph processing apparatus may determine, in the first graph, a node whose outdegree is greater than a second threshold. In this embodiment, this node is defined as a start node. Specifically, the second threshold indicates an outdegree of a data flow direction of nodes. That is, an outdegree of a node being greater than the second threshold indicates that the outdegree of the node already exceeds a preset outdegree, so that there are more data flow directions of the node, and therefore, there are more edges displayed in the graph. In addition, a specific value of the second threshold may be 2, 5, 8, or the like. Specific data of the second threshold needs to be determined in advance according to an actual situation in the first graph. This is not limited herein. Further, a corresponding end node is determined by using a path through which a data flow of the start node passes, and all subgraphs between two nodes are determined by using the start node and the end node. Because an outdegree of the start node is greater than the second threshold, there are at least two subgraphs between the start node and the end node, and each subgraph includes edges and nodes.

S103: For each subgraph of the at least two subgraphs, calculate an identifier corresponding to a node in each subgraph and an identifier corresponding to an edge in each subgraph.

In this embodiment, the identifier indicates a feature of the subgraph, or the identifier is a hash (hash) value of the subgraph. This is not specifically limited herein. In this embodiment, an example in which a computational graph corresponding to a deep learning framework is applied and an example in which the identifier is a hash value of a subgraph are used for description. Based on a feature of the deep learning computational graph, a graph processing apparatus may calculate hash values corresponding to the nodes and the edges in the subgraph of the computational graph. Because a hash value corresponding to a node may indicate a feature of the node, and a hash value corresponding to an edge may indicate a feature of the edge, nodes and edges with different features may be distinguished by using a hash value.

For example, a hash value corresponding to one subgraph computational node and a hash value corresponding to an edge are used as examples for description. The following separately describes calculation of the hash value corresponding to the node and the hash value corresponding to the edge.

1. Hash Value Corresponding to a Node

First, hash values are calculated for all nodes in the subgraph. Specifically, one node n in the subgraph is used as an example. Based on a feature of a deep learning computational graph, the node corresponds to a plurality of types of node attributes, and the node attribute corresponding to the node includes, but is not limited to, a variable type, a parameter type, a scope to which the node belongs, and the like. Therefore, a node attribute of the node n needs to be obtained first. In this embodiment, the node attribute includes a node type corresponding to the node n, a quantity of hidden input nodes in the node n, a type of hidden input nodes in the node n, and a quantity of hidden output nodes in the node n, a type of a hidden output node in the node n, and a quantity and a type of auxiliary nodes of the node n. The auxiliary node includes a constant node and a variable node.

Then, for each node attribute, a hash value corresponding to each node attribute of the node n is obtained by using a Time33 hash algorithm, and then the hash values corresponding to each node attribute are added up to obtain a node attribute hash value. Because the node corresponds to a plurality of node attributes, there may be a problem of hash value overflow. To prevent overflow, a big prime (BIG_PRIMITIVE) number modulo operation is performed on an edge hash value after the addition, so as to obtain a hash value node_hash[n] corresponding to the node n. Specifically, the big primitive number in this embodiment is 10000019. It should be understood that, in actual application, specific data corresponding to the big primitive number should be flexibly determined according to an actual situation. This is not specifically limited herein.

Further, because one subgraph includes at least two nodes, a hash value corresponding to each node is determined in a manner similar to that in the foregoing embodiment, and the hash values corresponding to all nodes are added up to obtain a node hash value after the addition. If there are a large number of nodes in the subgraph, there may be a problem of hash value overflow. To prevent overflow, a big primitive number modulo operation is performed on the node hash value after the addition, so as to obtain a hash value corresponding to the node in the subgraph.

2. Hash Value Corresponding to an Edge

First, hash values are calculated for all edges in the subgraph. A hash value corresponding to one edge is related to a connection relationship indicated by the edge in each subgraph, that is, the hash value corresponding to the edge in each subgraph is obtained by calculating a connection relationship that is between nodes and that is indicated by the edge in each subgraph, and the connection relationship between the nodes is directional. Specifically, an edge i in the subgraph is used as an example, and the edge i represents a data flow direction from a node A to a node B. That is, for the edge i, a node from which data is output is the node A, and a node into which data is input is the node B. In this case, the node A and the node B may be encoded into a character string “[source type]->[target type]”, where [source type] indicates a type of the node A of the edge i, while [target type] indicates a type of the node B of the edge i, and “[source type]->[target type]” indicates that the data flow direction of the edge i is from the node A to the node B, to ensure a data order. Then, a hash value edge_hash[i] corresponding to the edge i is obtained by performing a Time33 hash algorithm on the character string “[source type]->[target type]”, where the Time33 hash algorithm is specifically used to map the character string to a number.

Further, because one subgraph includes at least two edges, a hash value corresponding to each edge is determined in a manner similar to that in the foregoing embodiment, and the hash values corresponding to all edges are added up to obtain an edge hash value after the addition. If there are a large number of edges in the subgraph, there may be a problem of hash value overflow. To prevent overflow, a big primitive number modulo operation is performed on the edge hash value after the addition, so as to obtain a hash value corresponding to the edge in the subgraph.

It may be understood that, in this embodiment, an example in which the identifier is a hash value is used for description. However, in actual application, the identifier may further compare a node and an edge of the subgraph with a preset subgraph library, so as to obtain an identifier matching the subgraph. A structure of a similar subgraph corresponds to one identifier. Therefore, the identifier may indicate a feature of the subgraph, and subgraphs with different features may further be distinguished by using the identifier. Alternatively, based on a statistical value of the attribute of the node, the quantity of edges, and the connection relationship, a value is obtained by using other computational logic such as rounding and exact division, and the value is used as an identifier. The identifier may further indicate a feature of the subgraph, and subgraphs with different features may be distinguished by using the identifier. The identifier is not specifically limited herein. In addition, when the identifier is a hash value, a hash algorithm used for calculating the hash value is not particularly limited in this application, provided that subgraphs of different structures can be indicated, and hash values of similar subgraphs (including same subgraph) are the same.

S104: Calculate, based on the identifier corresponding to the node in each subgraph and the identifier corresponding to the edge in each subgraph, an identifier corresponding to each subgraph.

In this embodiment, an example in which the identifier is a hash value is used for description. The graph processing apparatus may obtain, by using step S103, a hash value corresponding to the node in each subgraph and a hash value corresponding to the edge in each subgraph, then add the obtained hash value corresponding to the node to the obtained hash value corresponding to the edge, and perform a big primitive number modulo operation, so as to obtain a hash value corresponding to each subgraph.

An example in which the first graph includes a subgraph A, a subgraph B, and a subgraph C is used. For the subgraph A, the subgraph B, and the subgraph C, a hash value corresponding to a node and a hash value corresponding to an edge in each subgraph may be obtained by performing step S103, and then the obtained hash value corresponding to the node is added to the hash value corresponding to the edge, and a big primitive number modulo operation is performed to obtain a hash value H(A) corresponding to the subgraph A, a hash value H(B) corresponding to the subgraph B, and a hash value H(C) corresponding to the subgraph C.

S105: Combine subgraphs with a same identifier in at least two subgraphs to generate a second graph.

In this embodiment, an example in which the identifier is a hash value is used for description. Because subgraphs that have a same hash value are similar, the graph processing apparatus may combine the at least two subgraphs that have a same hash value to generate the second graph, and the second graph is used for display on the terminal device, thereby reducing a quantity of nodes and edges, in the second graph, displayed on the terminal device. The combination described in this embodiment does not mean that the subgraphs are combined completely. Instead, the combination means that the subgraphs are stacked, so that a quantity of subgraphs in the generated second graph is reduced, while data contained in the subgraphs is not reduced due to the combination. An example in which the first graph includes a subgraph A, a subgraph B, and a subgraph C is used. A hash value H(A) corresponding to the subgraph A, a hash value H(B) corresponding to the subgraph B, and a hash value H(C) corresponding to the subgraph C are obtained by performing step S104. If the hash value H(A) is the same as the hash value H(B), the subgraph A and the subgraph B may be combined to generate the second graph. Therefore, only a corresponding structure of the subgraph A and the subgraph C is shown in the displayed second graph, thereby reducing a quantity of nodes and edges that are displayed in the computational graph.

S106: Output the second graph generated through combination.

In this embodiment, if this embodiment is applied to a server, the server may generate the second graph in the method in the foregoing embodiment, and send the generated second graph to a terminal device, so that the terminal device displays the second graph, or the server directly displays the second graph. In addition, if this embodiment is applied to the terminal device, the terminal device may directly generate the second graph in the method in the foregoing embodiment and display the generated second graph; or may receive the second graph sent by the server and then display the received second graph. Once again, a specific display method of the second graph is not limited.

According to the solution provided in this embodiment of this application, all frequent subgraphs at a same scope level can be accurately searched at one scope layer for stacking, and level-by-level stacking can be recursively performed to accurately identify a frequent subgraph structure. A quantity of nodes and edges that are displayed in the computational graph is reduced while accuracy of a connection relationship is ensured. An example in which a BERT pretrain (pretrain) network computational graph and a mobilenetV2 network computational graph that are generated based on an open source computational framework MindSpore is used for description. Table 1 is detailed information corresponding to the BERT_pretrain network computational graph and detailed information corresponding to the mobilenetV2 network computational graph.

TABLE 1

| | | Quantity of | Quantity of | |
|---|---|---|---|---|
| | | nodes in the | nodes after | |
| Network | Node | original image | being stacked | Effect |
| mobilenetV2 | Optimizer_Momentum | 650 | 33 | Display the graph |
| | | | | in 2 seconds |
| BERT_pretrain | Optimizer_Lamb | 16723 (crash) | 99 | Display the graph |
| | | | | in 5 seconds |

It can be seen from Table 1 that before the foregoing two computational graphs go through graph processing, a quantity of nodes in the original computational graph is relatively large. For Optimizer_Lamb nodes in a BERT_pretrain network, a quantity of nodes in the original graph is 16723, and the excessive large quantity of the nodes causes the terminal device to crash when the terminal device displays the nodes. However, after stacking processing is performed on the frequent subgraph in this embodiment of this application, for Optimizer_Lamb nodes in the BERT_pretrain network computational graph, the quantity of nodes is reduced from 16723, which causes a crash, to 99, and the terminal device can display the graph within 5 seconds. In addition, for the Optimizer_Momentum nodes in the mobilenetV2 network computational graph, the quantity of nodes is reduced from 650 to 33, and the terminal device can display the graph within 2 seconds. Therefore, it can be learned that according to the graph processing method provided in this embodiment of this application, the quantity of nodes in the computational graph can be reduced, and efficiency of displaying the computational graph by the terminal device can be further improved. It should be understood that the example in Table 1 is merely used to understand this solution, and specifically, needs to be flexibly determined based on an actual situation.

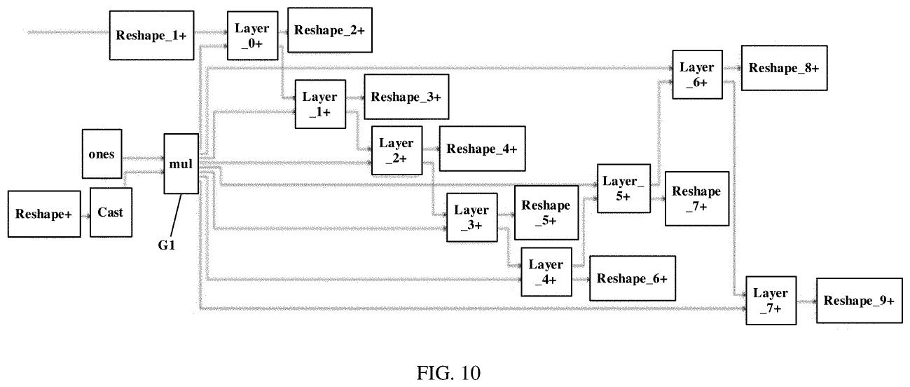

Further, a second graph is obtained by reducing the quantity of nodes and edges that are displayed in the foregoing embodiment, and an orthogonal arrangement is used as a basic arrangement style. The orthogonal arrangement is specifically that edges do not intersect each other, and all nodes at a same depth are on one horizontal line. In addition, there should be a given gap between nodes at the same level. However, a scale computational graph usually includes a large quantity of nodes and edges. Although the quantity of nodes and edges that are displayed is reduced through the foregoing embodiment, the quantity of edges and nodes is still relatively large, and there is still a problem that the computational graph that is display is not clear enough by using the orthogonal arrangement as the basic arrangement style. As a result, users cannot perform training, analysis, and debugging based on the graph. For ease of understanding, FIG. 10 is a schematic diagram of an embodiment of a computational graph according to an embodiment of this application. As shown in the figure, G1 indicates a multiplication instruction (mul) operator, and there are 10 edges connected to a mul operator G1. If all the 10 edges are displayed in the computational graph, there are excessive edges that are connected to the mul operator G1, and a relationship between the edges that are connected to the mul operator G1 and a data flow direction of the mul operator G1 cannot be clearly displayed in the computational graph, which is inconducive to analysis of the computational graph.

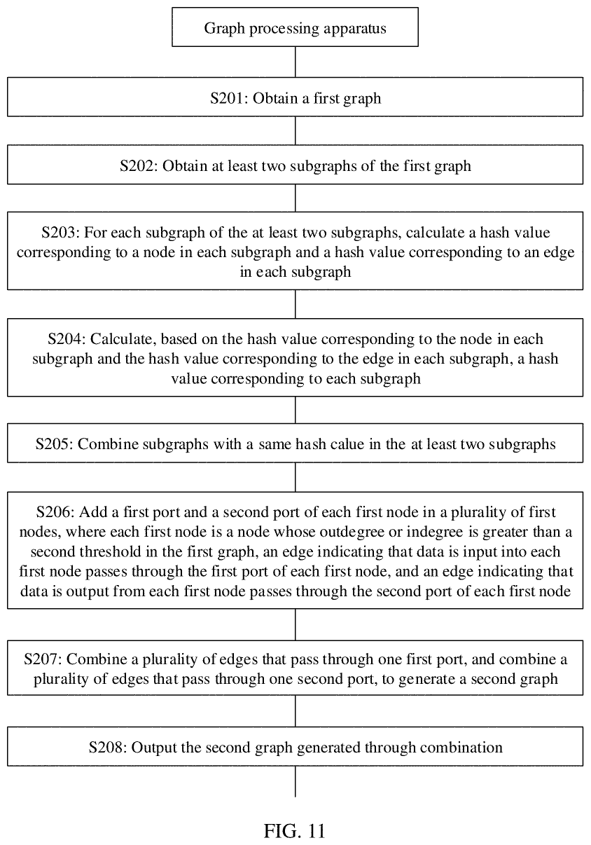

Therefore, to resolve the problem in FIG. 10, an embodiment of this application provides another graph processing method. In this embodiment of this application, an example in which the identifier is a hash value is used for description. FIG. 11 is a schematic diagram of another embodiment of a graph processing method according to an embodiment of this application. As shown in the figure, the graph processing method includes the following steps.

S201: Obtain a first image.

In this embodiment, the method in which the graph processing apparatus obtains the first graph is similar to the method in step S101, and details are not described herein again.

S202: Obtain at least two subgraphs of the first graph.

In this embodiment, the method in which the graph processing apparatus obtains the at least two subgraphs of the first graph is similar to the method in step S102, and details are not described herein again.

S203: For each subgraph of the at least two subgraphs, calculate a hash value corresponding to a node in each subgraph and a hash value corresponding to an edge in each subgraph.

In this embodiment, the method in which the graph processing apparatus calculates, for each subgraph of the at least two subgraphs, the hash value corresponding to the node in each subgraph and the hash value corresponding to the edge in each subgraph is similar to the method in step S103, and details are not described herein again.

S204: Calculate, based on the hash value corresponding to the node in each subgraph and the hash value corresponding to the edge in each subgraph, a hash value corresponding to each subgraph.

In this embodiment, the method in which the graph processing apparatus calculates, based on the hash value corresponding to the node in each subgraph and the hash value corresponding to the edge in each subgraph, the hash value corresponding to each subgraph is similar to the method in step S104, and details are not described herein again.

S205: Combine subgraphs, of the at least two subgraphs, that have a same hash value.

In this embodiment, the method in which the graph processing apparatus combines subgraphs with a same hash value in of the at least two subgraphs is similar to the manner described in step S105, and details are not described herein again.

S206: Add a first port and a second port of each first node in a plurality of first nodes, where each first node is a node whose outdegree or indegree is greater than a first threshold in the first graph, an edge indicating that data is input into each first node passes through the first port of each first node, and an edge indicating that data is output from each first node passes through the second port of each first node.

In this embodiment, after the graph processing apparatus combines subgraphs, of the at least two subgraphs, that have a same hash value, the graph processing apparatus may traverse all nodes in the graph generated through combination, and determine a node whose outdegree or indegree is greater than the first threshold. Such a node is determined as a first node. Then, a first port and a second port are allocated to the first node. The first port is a port, of each subgraph, through which an edge indicating that data is input into each first node passes, and the second port is a port, of each first node, through which an edge indicating that data is output from each first node passes. Specifically, the first threshold may indicate an outdegree of a data flow direction of the node, or may indicate an indegree of data inflow of the node. That is, an outdegree of a node being greater than the first threshold indicates that the outdegree of the node exceeds a preset outdegree, or an indegree of a node being greater than the threshold indicates that the indegree of the node exceeds a preset indegree, which both indicate a relatively large quantity of data flow directions of the node. Therefore, there are a relatively large quantity of edges shown in the figure. In addition, a specific value of the first threshold may be 3, 5, 4, or the like, and specific data of the first threshold needs to be predetermined according to an actual situation of the computational graph. This is not limited herein.

S207: Combine a plurality of edges that pass through one first port, and combine a plurality of edges that pass through one second port to generate a second graph.

In this embodiment, based on all edges included in the graph generated through combination, the graph processing apparatus combines the plurality of edges that pass through one first port and combines the plurality of edges that pass through one second port to generate the second graph.

Optionally, the second graph is arranged in an orthogonal edge routing manner. Specifically, based on the first port and the second port, a port constraint optimized arrangement algorithm is first used to perform constraint optimization on locations and sequences of the first port and the second port with an overall orthogonal edge routing arrangement as a target, to obtain location coordinates of the first port and the second port through calculation, so that the orthogonal edge routing arrangement is completed and the second graph is generated. The orthogonal arrangement is specifically that an included angle of connection lines around the node is 90 degrees, and edge routing is an arrangement and directions of specific connection lines in the figure.

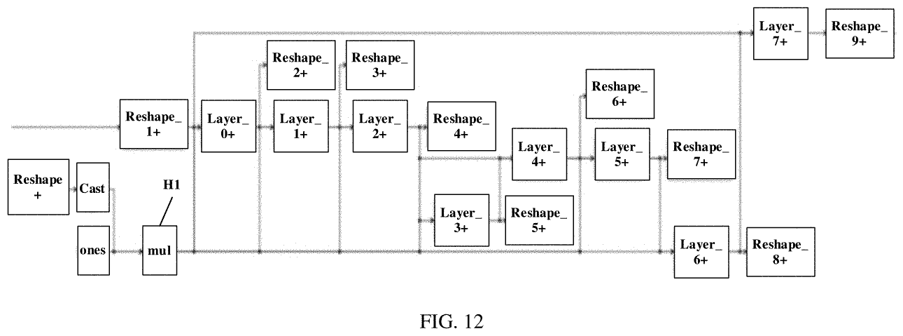

For ease of understanding, FIG. 12 is a schematic diagram of another embodiment of a computational graph according to an embodiment of this application. As shown in the figure, H1 indicates a mul operator. In the figure shown in FIG. 10, edges that indicate a data input and that pass through the first port are combined with edges that indicate a data output and that pass through the second port, and FIG. 12 is generated by using the orthogonal edge routing manner, so that a quantity of connected edges displayed by the terminal device in the graph is reduced. Therefore, a large-scale computational graph that has a relatively large quantity of nodes and edges can be clearly displayed, thereby further improving clarity of the computational graph, and helping users perform training, analysis, and debugging based on the graph.

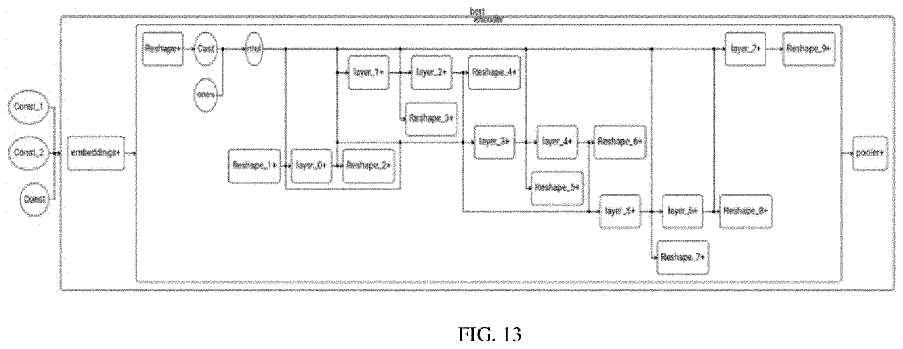

For example, the method corresponding to the foregoing embodiment is performed on a computational graph of a bidirectional encoder representation from transformer (Bidirectional Encoder Representation from Transformers, BERT) network to obtain a visualized graph by using an orthogonal edge routing arrangement. FIG. 13 is a schematic diagram of an embodiment of a BERT network computational graph according to an embodiment of this application. As shown in the figure, for a large-scale computational graph such as the BERT graph, after graph processing is performed by using the foregoing method, an overall data flow direction from left to right in the obtained graph is complete and clear. Therefore, after the terminal device displays the graph, users may interactively click an operator in the graph to view finer substructures. It should be understood that the examples corresponding to FIG. 12 and FIG. 13 are merely used to understand this solution, and specifically, needs to be flexibly determined based on an actual situation.

S208: Output the second graph generated through combination.

In this embodiment, the method in which the graph processing apparatus outputs the second graph generated through combination is similar to the method in step S106, and details are not described herein again.

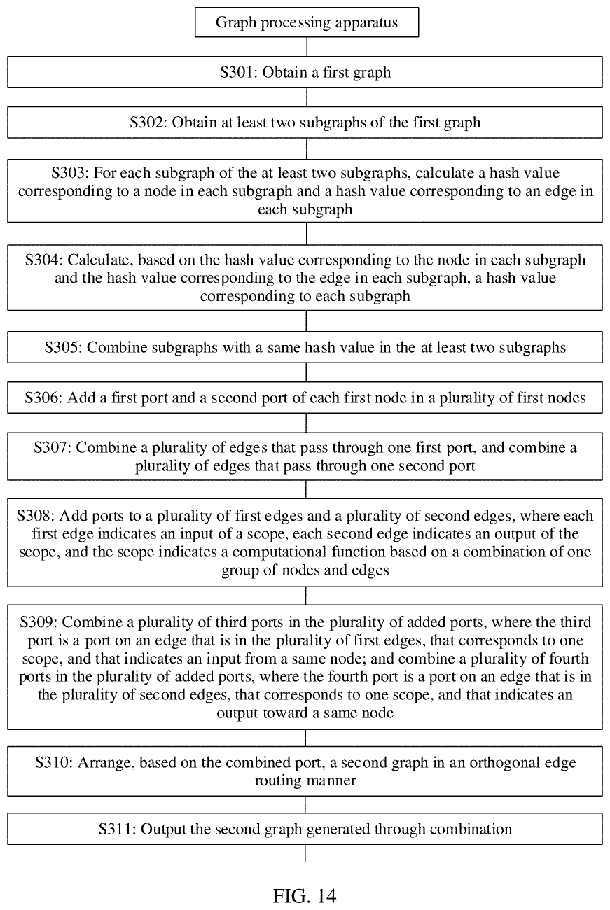

Still further, after the second graph is obtained by improving clarity of the computational graph by using the foregoing embodiment, because nodes that have a connection relationship may belong to scopes at different levels, the scope is a set that includes some subnodes, that is, scope information may be contained in the computational graph. Refer to FIG. 7 again. It can be learned from FIG. 7 that when a scope exists in a computational graph, because one scope includes at least one node, there are interlocking and complex edges between scopes. As a result, when a computational graph is a compound graph, the computational graph still has a problem that the displayed computational graph is not clear enough. Therefore, to resolve a corresponding problem during display of the compound graph shown in FIG. 7, an embodiment of this application provides another graph processing method. An example in which the identifier is a hash value is used for description in this embodiment of this application. FIG. 14 is a schematic diagram of another embodiment of a graph processing method according to an embodiment of this application. As shown in the figure, a fourth graph includes a scope, and the graph processing method includes the following steps.

S301: Obtain a first graph.

In this embodiment, the method in which the graph processing apparatus obtains the first graph is similar to the method in step S201, and details are not described herein again.

S302: Obtain at least two subgraphs of the first graph.

In this embodiment, the method in which the graph processing apparatus obtains the at least two subgraphs of the first graph is similar to the method in step S202, and details are not described herein again.

S303: For each subgraph of the at least two subgraphs, calculate a hash value corresponding to a node in each subgraph and a hash value corresponding to an edge in each subgraph.

In this embodiment, the method in which the graph processing apparatus calculates, for each subgraph of the at least two subgraphs, the hash value corresponding to the node in each subgraph and the hash value corresponding to the edge in each subgraph is similar to the method in step S203, and details are not described herein again.

S304: Calculate, based on the hash value corresponding to the node in each subgraph and the hash value corresponding to the edge in each subgraph, a hash value corresponding to each subgraph.

In this embodiment, the method in which the hash value corresponding to each subgraph is calculated based on the hash value corresponding to the node in each subgraph and the hash value corresponding to the edge in each subgraph is similar to the method in step S204, and details are not described herein again.

S305: Combine subgraphs, of the at least two subgraphs, that have a same hash value.

In this embodiment, the method in which the graph processing apparatus combines subgraphs with a same hash value in the at least two subgraphs is similar to that in step S205, and details are not described herein again.

S306: Add a first port and a second port of each first node in a plurality of first nodes.

In this embodiment, the method in which the graph processing apparatus adds the first port and the second port of each first node in the plurality of first nodes is similar to the method in step S206, and details are not described herein again.

S307: Combine a plurality of edges that pass through one first port, and combine a plurality of edges that pass through one second port.

In this embodiment, the method in which the graph processing apparatus combines the plurality of edges that pass through one first port and the plurality of edges that pass through one second port is similar to the method in step S207, and details are not described herein again.

S308: Add ports to a plurality of first edges and a plurality of second edges, where each first edge indicates an input of a scope, each second edge indicates an output of the scope, and the scope indicates a computational function by using a combination of one group of nodes and edges.

In this embodiment, because a scope exists in the computational graph, after the graph processing apparatus combines the plurality of edges that pass through one first port and combines the plurality of edges that pass through one second port, a graph is obtained and includes a scope. Therefore, the graph processing apparatus may first determine, based on a node included in a scope and a data flow direction between nodes outside the scope, the first edge and the second edge, where both the first edge and the second edge are cross-scope edges described in FIG. 8. Specifically, the first edge indicates one data input of a scope, the second edge indicates one data output of the scope, and the scope may indicate a computational function by using a combination of one group of nodes and edges.

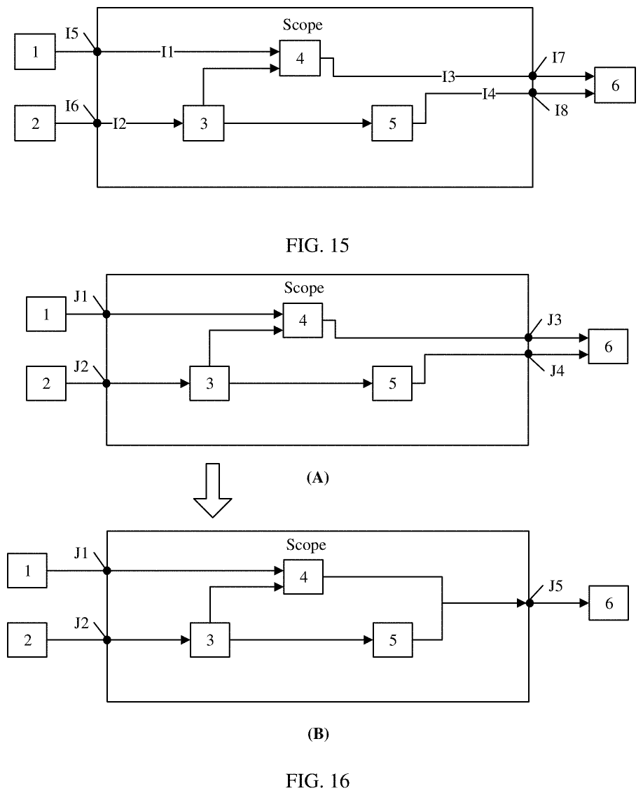

Further, after the graph processing apparatus determines the first edge and the second edge, the graph processing apparatus may further add ports to the first edge and the second edge. It should be understood that for one scope, a quantity of ports is the same as a quantity of first edges and second edges corresponding to the scope. For example, if there are three data inputs and two data outputs in one scope, it can be determined that there are three first edges, and two second edges. In this case, five ports are added to the graph processing apparatus. For ease of understanding, FIG. 15 is a schematic diagram of an embodiment of a port according to an embodiment of this application. As shown in the figure, I1 and I2 indicate first edges, I3 and I4 indicate second edges, and I5 to I8 indicate ports. The figure includes one scope and six nodes. For the scope, none of a node 1, a node 2, and a node 6 belong to the scope, but the scope includes a node 3, a node 4, and a node 5. It can be learned from the foregoing embodiment that: a data flow direction between the node 1 and the node 4 corresponds to an edge I1, and the edge I1 indicates a data input of the scope. Therefore, the edge I1 is a first edge. Similarly, it can be learned that an edge I2 corresponding to a data flow direction between the node 2 and the node 3 may indicate a data input of the scope. Therefore, the edge I2 is a first edge. In addition, a data flow direction between the node 4 and the node 6 corresponds to an edge I3, and the edge I3 indicates a data output of the scope. Therefore, the edge I3 is a second edge. Similarly, it can be learned that an edge I4 corresponding to a data flow direction between the node 5 and the node 6 may indicate a data output of the scope. Therefore, the edge I4 is a first edge, that is, two first edges and two second edges may be determined. Based on each first edge and each second edge, ports are added at intersection points between the edges and the scope, that is, an intersection point I5 between the first edge I1 and the scope is a port. Similarly, it can be learned that an intersection point 16 between the first edge I2 and the scope is a port. An intersection point 17 between the second edge I3 and the scope is a port, and an intersection point I8 between the second edge I4 and the scope is a port. That is, 4 ports corresponding to the two first edges and the two second edges may be added. It should be understood that the example in FIG. 15 is merely used to understand this solution. A specific first edge and a specific second edge need to be flexibly determined based on an actual situation of a data flow direction relationship of the nodes in the figure, and a specific added port needs to be flexibly determined based on an actual situation of the first edge and the second edge.

S309: Combine a plurality of third ports in the plurality of added ports, where the third port is a port on an edge that is in the plurality of first edges, that corresponds to one scope, and that indicates an input from a same node; and combine a plurality of fourth ports in the plurality of added ports, where the fourth port is a port on an edge that is in the plurality of second edges, that corresponds to one scope, and that indicates an output toward a same node.

In this embodiment, the graph processing apparatus traverses all nodes in the scope, determines a port on an edge that is in the plurality of first edge, that corresponds to one scope, and that indicates an input from a same node, and combines a plurality of third ports. In addition, a port on an edge that is in the plurality of second edges, that corresponds to one scope, and that indicates an output toward a same node is determined as a fourth port, and the plurality of fourth ports are combined.

For ease of understanding, a further example based on the port in FIG. 15 is used for description. FIG. 16 is a schematic diagram of an embodiment of combining a port according to an embodiment of this application. As shown in the figure, J1 to J4 indicate ports, and J5 indicates a fourth port. In FIG. 16, a diagram (A) is an example diagram that includes a port J1 to a port J4, where both the port J3 and the port J4 are separately connected to a node 6, that is, data flow directions of a node 4 and a node 5 in the scope point to the node 6. That is, the port J3 and the port J4 are ports on the edge that is of two second edges, that corresponds to one scope, and that indicates an output toward a same node. Therefore, the port J3 and the port J4 may be combined to obtain a fourth port, so that an example diagram, in a diagram (B) of FIG. 16, that includes the port J1, the port J2, and the fourth port J5 is obtained. It should be understood that the example in FIG. 16 is merely used to understand this solution. Specifically, the third port and the fourth port need to be flexibly determined based on an actual situation of data flow directions between nodes in a scope and nodes outside the scope.

S310: Arrange, based on the combined port, the second graph in an orthogonal edge routing manner.

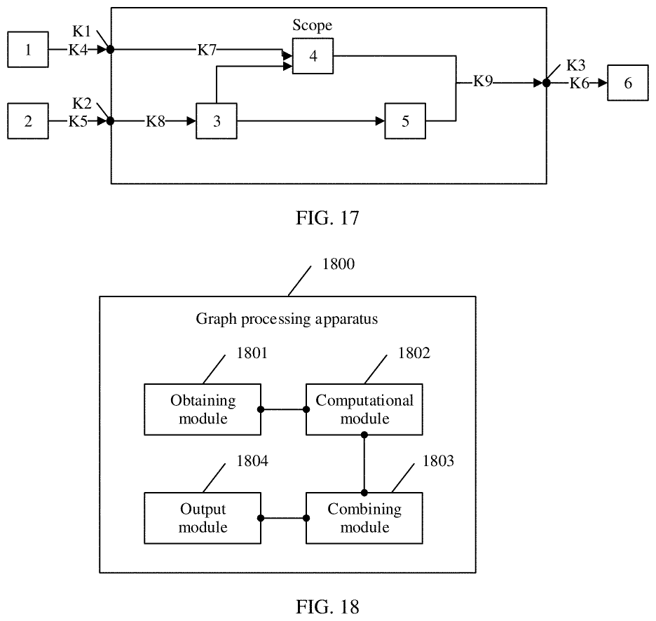

In this embodiment, the graph processing apparatus arranges, based on the combined port, the second graph in the orthogonal edge routing manner. Specifically, first, the first edge is split into two segments by using the third port as a boundary, and then the second edge is split into two segments by using the fourth port as a boundary. If there is no third port or fourth port, the first edge or the second edge may be split into two segments by using a port as a boundary. This is not specifically limited herein. For ease of understanding, a further example based on the fourth port in FIG. 16 is used for description. FIG. 17 is a schematic diagram of yet another embodiment of a graph processing method according to an embodiment of this application. As shown in the figure, K1 and K2 indicate ports, K3 indicates a fourth port, K4, K5, and K6 indicate edges outside a scope, and K7 to K9 indicate edges inside the scope. Based on a port K1, a first edge corresponding to data of a scope that is input from a node 1 to a node 4 is split, so as to obtain an edge K4 and an edge K7. Similarly, it can be learned that an edge K5 and an edge K8 may be obtained based on a port K2. In addition, based on a fourth port K3, a second edge corresponding to data of a scope that is output from the node 4 to a node 6, and from a node 5 to the node 6 may be split, so as to obtain an edge K6 and an edge K9. Then, a port constraint optimized arrangement algorithm is used to perform an arrangement calculation on the nodes and the edges inside and outside the scope by using the ports on the scope and the fourth port as a boundary, and a quantity, a location, and a sequence of the nodes and the ports are constrained to be adjusted, so as to generate the second graph. A specific arrangement manner of the orthogonal edge routing is described in the foregoing embodiment, and details are not described herein again.

S311: Output the second graph generated through combination.

In this embodiment, the method in which the graph processing apparatus outputs the second graph generated through combination is similar to the method in step S208, and details are not described herein again.

It can be learned from the foregoing embodiment that in this embodiment of this application, a port design and rule-based edge binding are used in a data edge of a cross-node scope, so that a quantity of edges can be reduced, a complete data flow direction of a local focus area can be retained. In addition, for processing of connection lines inside and outside the scope, a port constraint optimized arrangement algorithm is used to adaptively adjust and limit locations and a quantity of nodes and ports that are at a boundary of the scope, so that different computational graph structures can be more universally adapted, and an original local data connection relationship can be retained as much as possible while a graph arrangement is simplified.

It should be understood that there is no limitation on a time sequence between steps in the foregoing embodiments. For example, between step S305, step S306, and step S307, step S306 and step S307 may be implemented first, and then step S305 is implemented. In addition, for example, between step S306 to step S307 and step S308 to step S310, step S308 to step S310 may be implemented first, and then step S306 to step S307 are implemented. Therefore, in all examples in this embodiment, a time sequence between steps may be adjusted according to an actual situation. This is not specifically limited herein.

The foregoing mainly describes the solutions provided in embodiments of this application from the perspective of the methods. It may be understood that, to implement the foregoing functions, the graph processing apparatus contains a hardware structure and/or a software module for performing a corresponding function. A person of ordinary skill in the art should easily be aware that, in combination with the examples described in embodiments disclosed in this specification, modules, algorithms and steps may be implemented by hardware or a combination of hardware and computer software. Whether a function is performed by hardware or hardware driven by computer software depends on a particular application and a design constraint of the technical solutions. A person skilled in the art may use a different method to implement the described functions for each particular application, but it should not be considered that the implementation goes beyond the scope of this application.

In embodiments of this application, the graph processing apparatus may be divided into functional modules based on the foregoing method examples. For example, each functional module may be obtained, based on a corresponding function, through division, or two or more functions may be integrated into one processing module. The integrated module may be implemented in a form of hardware, or may be implemented in a form of a software functional module. It should be noted that, in embodiments of this application, division of the modules is an example and is merely logical function division, and may be another division in an actual implementation.

Therefore, the following describes in detail a graph processing apparatus in this application. FIG. 18 is a schematic diagram of an embodiment of a graph processing apparatus according to an embodiment of this application. As shown in the figure, the graph processing apparatus 1800 includes:

an obtaining module 1801, configured to obtain at least two subgraphs of a first graph, where each subgraph includes, in the first graph, a plurality of nodes and edges between the nodes;

a computational module 1802, configured to calculate respective identifiers of the at least two subgraphs based on the nodes and the edges that are included in each subgraph of the at least two subgraphs;

a combining module 1803, configured to combine subgraphs with a same identifier in the at least two subgraphs; and

an output module 1804, configured to output a second graph generated through combination.

In some optional embodiments of this application, the identifier is a hash value, and the data of each subgraph indicates nodes and edges in each subgraph.

The computational module 1802 is specifically configured to, for each of the at least two subgraphs, calculate, based on hash values respectively corresponding to the plurality of nodes in each subgraph and hash values corresponding to the plurality of edges in each subgraph, a hash value corresponding to each subgraph.

In some optional embodiments of this application, in each subgraph, a hash value corresponding to one node is related to an attribute of the node.

In each subgraph, a hash value corresponding to one edge is related to a connection relationship indicated by the edge in each subgraph.

In some optional embodiments of this application, the identifier is a hash value.

The combining module 1803 is specifically configured to combine subgraphs, of the at least two subgraphs, that have a same hash value;

add a first port and a second port of each first node in a plurality of first nodes, where each first node is a node whose outdegree or indegree is greater than a first threshold in the first graph, an edge indicating that data is input into each first node passes through the first port of each first node, and an edge indicating that data is output from each first node passes through the second port of each first node; and

perform the following operations on the plurality of first nodes to generate the second graph:

combining a plurality of edges that pass through one first port, and combining a plurality of edges that pass through one second port.

In some optional embodiments of this application, the second graph is arranged in an orthogonal edge routing manner.

In some optional embodiments of this application, the identifier is a hash value.

The combining module 1803 is specifically configured to combine subgraphs, of the at least two subgraphs, that have a same hash value;

add ports to a plurality of first edges and a plurality of second edges, where each first edge indicates an input of a scope, each second edge indicates an output of the scope, and the scope indicates a computational function by using a combination of one group of nodes and edges;

combine a plurality of third ports in the plurality of added ports, where the third port is a port on an edge that is in the plurality of first edges, that corresponds to one scope, and that indicates an input from a same node; and combine a plurality of fourth ports in the plurality of added ports, where the fourth port is a port on an edge that is in the plurality of second edges, that corresponds to one scope, and that indicates an output toward a same node; and

arrange, based on the combined port, the second graph in an orthogonal edge routing manner.

In some optional embodiments of this application, the identifier is a hash value.

The combining module 1803 is specifically configured to combine subgraphs, of the at least two subgraphs, that have a same hash value;

add a first port and a second port of each first node in a plurality of first nodes, where each first node is a node whose outdegree or indegree is greater than a first threshold in the first graph, an edge indicating that data is input into each first node passes through the first port of each first node, and an edge indicating that data is output from each first node passes through the second port of each first node;

combine a plurality of edges that pass through one first port, and combine a plurality of edges that pass through one second port;

add ports to a plurality of first edges and a plurality of second edges, where each first edge indicates an input of a scope, each second edge indicates an output of the scope, and the scope indicates a computational function by using a combination of one group of nodes and edges;

combine a plurality of third ports in the plurality of added ports, where the third port is a port on an edge that is in the plurality of first edges, that corresponds to one scope, and that indicates an input from a same node; and combine a plurality of fourth ports in the plurality of added ports, where the fourth port is a port on an edge that is in the plurality of second edges, that corresponds to one scope, and that indicates an output toward a same node; and

arrange, based on a result of one or more of the foregoing combination steps, the second graph in an orthogonal edge routing manner.

The graph processing apparatus in embodiments of this application may be deployed on a terminal device, or may be deployed on a server, or may be applied to a chip in the terminal device or the server, or another combined component, part, or the like that can implement functions of the foregoing terminal device. When the graph processing apparatus is a terminal device, the computational module and the combining module may be implemented by a processor that executes code. For example, the processor may be an application chip of a specific model. When the graph processing apparatus is a component having a function of the foregoing terminal device, the computational module and the combining module may be implemented by the processor that executes code. When the graph processing apparatus is a chip system, the computational module and the combining module may be a processor of the chip system.

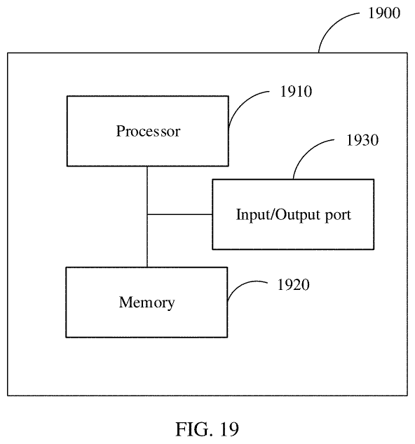

Specifically, FIG. 19 is a schematic diagram of an embodiment of a structure of a graph processing apparatus according to an embodiment of this application. As shown in FIG. 19, the graph processing apparatus 1900 includes a processor 1910, a memory 1920 that is coupled to the processor 1910, and an input/output port 1930. In some implementations, they may be coupled together through a bus. The graph processing apparatus 1900 may be a server or a terminal device. The processor 1910 may be a central processing unit (central processing unit, CPU), a network processor (network processor, NP), or a combination of a CPU and an NP. The processor may also be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable logic gate array (field-programmable gate array, FPGA), a generic array logic (generic array logic, GAL), or any combination thereof. The processor 1910 may be one processor, or may include a plurality of processors. The memory 1920 may include a volatile memory (volatile memory), for example, a random access memory (random access memory, RAM). The processor 1910 may execute code to implement functions of the computational module 1802 and the combining module 1803. The memory 1920 may also include a non-volatile memory (non-volatile memory), for example, a read-only memory (read-only memory, ROM), a flash memory (flash memory), a hard disk drive (hard disk drive, HDD), or a solid-state drive (solid-state drive, SSD). The memory 1920 may further include a combination of memories of the foregoing categories.

The memory 1920 stores a computer-readable instruction, and the computer-readable instruction performs any method in the possible implementations described above. After the processor 1910 executes the computer-readable instruction, the processor 1910 may perform a corresponding operation according to the computer-readable instruction. In addition, after the processor 1910 executes the computer-readable instruction in the memory 1920, the processor 1910 may perform, according to the computer-readable instruction, all operations that can be performed by the server or the terminal device, for example, operations performed by the server in the embodiments corresponding to FIG. 9, FIG. 11, and FIG. 14.

The input/output port 1930 includes a port used for outputting data, and in some cases, a port used for inputting data. The processor 1910 may invoke the input/output port 1930 by executing code to output the second graph. In some cases, the processor 1910 may further invoke the input/output port 1930 by executing code to obtain two subgraphs of the first graph from another device.

It may be clearly understood by a person skilled in the art that, for the purpose of convenient and brief description, for a detailed working process, description of the working process, and technical effects of the foregoing system, apparatus, and unit, reference may be made to a corresponding process in the foregoing method embodiments, and details are not described herein again.

In the several embodiments provided in this application, it should be understood that the disclosed system, apparatus, and method may be implemented in another manner. For example, the described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be indirect couplings or communication connections through some interfaces, apparatuses or units, and may be in electrical, mechanical, or other forms.

The units described as separate parts may or may not be physically separate. Components displayed as units may or may not be physical units, that is, they may be located in one position, or may be distributed on a plurality of network units. Some or all of the units may be selected based on actual requirements to achieve the objectives of the solutions of embodiments.

In addition, functional units in embodiments of this application may be integrated into one processing unit, each of the units may exist alone physically, or two or more units may be integrated into one unit. The integrated unit may be implemented in a form of hardware, or may be implemented in a form of a software function unit.

When the integrated unit is implemented in the form of a software functional unit and sold or used as an independent product, the integrated unit may be stored in a computer-readable storage medium. Based on such an understanding, the technical solutions of this application essentially, or the part contributing to the prior art, or all or some of the technical solutions may be embodied in the form of a software product. The computer software product is stored in a storage medium, and includes several instructions for instructing a computer device (which may be a personal computer, a server, a network device, or the like) to perform all or some of the steps of the methods described in embodiments of this application. The foregoing storage medium includes any medium that can store program code, such as a USB flash drive, a removable hard disk, a read-only memory (ROM, read-only memory), a random access memory (RAM, random access memory), a magnetic disk, or an optical disc.

What is claimed is:

1. A graph processing method, comprising:
obtaining at least two subgraphs of a first graph, wherein each subgraph comprises, in the first graph, a plurality of nodes and edges between the nodes;
calculating respective identifiers of the at least two subgraphs based on the nodes and the edges that are comprised in each subgraph of the at least two subgraphs;
combining subgraphs with a same identifier in the at least two subgraphs; and
outputting a second graph generated through combination.

2. The method according to claim 1, wherein the identifier is a hash value, and data of each subgraph indicates the nodes and the edges in each subgraph; and
the calculating respective identifiers of the at least two subgraphs based on the nodes and the edges that are comprised in each subgraph of the at least two subgraphs comprises:
for each subgraph of the at least two subgraphs, calculating, based on hash values respectively corresponding to the plurality of nodes in each subgraph and hash values corresponding to the plurality of edges in each subgraph, a hash value corresponding to each subgraph.

3. The method according to claim 2, wherein in each subgraph, a hash value corresponding to one node is related to an attribute of the node; and
in each subgraph, a hash value corresponding to one edge is related to a connection relationship indicated by the edge in each subgraph.

4. The method according to claim 1, wherein the identifier is a hash value; and
the combining subgraphs with a same identifier in the at least two subgraphs comprises:
combining subgraphs with a same hash value in the at least two subgraphs;
adding a first port and a second port of each first node in a plurality of first nodes, wherein each first node is a node whose outdegree or indegree is greater than a first threshold in the first graph, an edge indicating that data is input into each first node passes through the first port of each first node, and an edge indicating that data is output from each first node passes through the second port of each first node; and
performing the following operations on the plurality of first nodes to generate the second graph:
combining a plurality of edges that pass through one first port, and combining a plurality of edges that pass through one second port.

5. The method according to claim 4, wherein the second graph is arranged in an orthogonal edge routing manner.

6. The method according to claim 1, wherein the identifier is a hash value; and
the combining subgraphs with a same identifier in the at least two subgraphs comprises:
combining subgraphs with a same hash value in the at least two subgraphs;
adding ports to a plurality of first edges and a plurality of second edges, wherein each first edge indicates an input of a scope, each second edge indicates an output of the scope, and the scope indicates a computational function based on a combination of one group of nodes and edges;
combining a plurality of third ports in the plurality of added ports, wherein the third port is a port on an edge that is in the plurality of first edges, that corresponds to one scope, and that indicates an input from a same node; and combining a plurality of fourth ports in the plurality of added ports, wherein the fourth port is a port on an edge that is in the plurality of second edges, that corresponds to one scope, and that indicates an output toward a same node; and
arranging the second graph in an orthogonal edge routing manner based on a combined port.

7. The method according to claim 1, wherein the identifier is a hash value; and
the combining subgraphs with a same identifier in the at least two subgraphs comprises:
combining subgraphs with a same hash value in the at least two subgraphs;
adding a first port and a second port of each first node in a plurality of first nodes, wherein each first node is a node whose outdegree or indegree is greater than a first threshold in the first graph, an edge indicating that data is input into each first node passes through the first port of each first node, and an edge indicating that data is output from each first node passes through the second port of each first node;
combining a plurality of edges that pass through one first port, and combining a plurality of edges that pass through one second port;
adding ports to a plurality of first edges and a plurality of second edges, wherein each first edge indicates an input of a scope, each second edge indicates an output of the scope, and the scope indicates a computational function based on a combination of one group of nodes and edges;
combining a plurality of third ports in the plurality of added ports, wherein the third port is a port on an edge that is in the plurality of first edges, that corresponds to one scope, and that indicates an input from a same node; and combining a plurality of fourth ports in the plurality of added ports, wherein the fourth port is a port on an edge that is in the plurality of second edges, that corresponds to one scope, and that indicates an output toward a same node; and
arranging the second graph in an orthogonal edge routing manner based on a result of one or more of the foregoing combination steps.

8. A graph processing apparatus, comprising:
at least one processor; and
at least one processor memory coupled to the at least one processor to store program instructions, which when executed by the processor, cause the at least one processor to:
obtain at least two subgraphs of a first graph, wherein each subgraph comprises, in the first graph, a plurality of nodes and edges between the nodes;
calculate respective identifiers of the at least two subgraphs based on the nodes and the edges that are comprised in each subgraph of the at least two subgraphs;
combine subgraphs with a same identifier in the at least two subgraphs; and
output a second graph generated through combination.

9. The apparatus according to claim 8, wherein the identifier is a hash value, and data of each subgraph indicates the nodes and the edges in each subgraph; and
the calculating respective identifiers of the at least two subgraphs based on the nodes and the edges that are comprised in each subgraph of the at least two subgraphs further cause the at least one processor to:
for each subgraph of the at least two subgraphs, calculate, based on hash values respectively corresponding to the plurality of nodes in each subgraph and hash values corresponding to the plurality of edges in each subgraph, a hash value corresponding to each subgraph.

10. The apparatus according to claim 9, wherein in each subgraph, a hash value corresponding to one node is related to an attribute of the node; and
in each subgraph, a hash value corresponding to one edge is related to a connection relationship indicated by the edge in each subgraph.

11. The apparatus according to claim 8, wherein the identifier is a hash value; and
the combining subgraphs with a same identifier in the at least two subgraphs, further cause the at least one processor to:
combine subgraphs with a same hash value in the at least two subgraphs;
add a first port and a second port of each first node in a plurality of first nodes, wherein each first node is a node whose outdegree or indegree is greater than a first threshold in the first graph, an edge indicating that data is input into each first node passes through the first port of each first node, and an edge indicating that data is output from each first node passes through the second port of each first node; and
perform the following operations on the plurality of first nodes to generate the second graph:
combine a plurality of edges that pass through one first port, and combining a plurality of edges that pass through one second port.

12. The apparatus according to claim 11, wherein the second graph is arranged in an orthogonal edge routing manner.

13. The apparatus according to claim 8, wherein the identifier is a hash value; and
the combining subgraphs with a same identifier in the at least two subgraphs further cause the at least one processor to:
combine subgraphs with a same hash value in the at least two subgraphs;
add ports to a plurality of first edges and a plurality of second edges, wherein each first edge indicates an input of a scope, each second edge indicates an output of the scope, and the scope indicates a computational function based on a combination of one group of nodes and edges;
combine a plurality of third ports in the plurality of added ports, wherein the third port is a port on an edge that is in the plurality of first edges, that corresponds to one scope, and that indicates an input from a same node; and combining a plurality of fourth ports in the plurality of added ports, wherein the fourth port is a port on an edge that is in the plurality of second edges, that corresponds to one scope, and that indicates an output toward a same node; and
arrange the second graph in an orthogonal edge routing manner based on a combined port.

14. The apparatus according to claim 8, wherein the identifier is a hash value; and
the combining subgraphs with a same identifier in the at least two subgraphs further cause the at least one processor to:
combine subgraphs with a same hash value in the at least two subgraphs;
add a first port and a second port of each first node in a plurality of first nodes, wherein each first node is a node whose outdegree or indegree is greater than a first threshold in the first graph, an edge indicating that data is input into each first node passes through the first port of each first node, and an edge indicating that data is output from each first node passes through the second port of each first node;
combine a plurality of edges that pass through one first port, and combining a plurality of edges that pass through one second port;
add ports to a plurality of first edges and a plurality of second edges, wherein each first edge indicates an input of a scope, each second edge indicates an output of the scope, and the scope indicates a computational function based on a combination of one group of nodes and edges;
combine a plurality of third ports in the plurality of added ports, wherein the third port is a port on an edge that is in the plurality of first edges, that corresponds to one scope, and that indicates an input from a same node; and combining a plurality of fourth ports in the plurality of added ports, wherein the fourth port is a port on an edge that is in the plurality of second edges, that corresponds to one scope, and that indicates an output toward a same node; and
arrange the second graph in an orthogonal edge routing manner based on a result of one or more of the foregoing combination steps.

15. A non-transitory computer-readable storage medium, storing one or more instructions that, when executed by at least one processor, cause the at least one processor to:
obtain at least two subgraphs of a first graph, wherein each subgraph comprises, in the first graph, a plurality of nodes and edges between the nodes;
calculate respective identifiers of the at least two subgraphs based on the nodes and the edges that are comprised in each subgraph of the at least two subgraphs;
combine subgraphs with a same identifier in the at least two subgraphs; and
output a second graph generated through combination.

16. The non-transitory computer-readable storage medium according to claim 15, wherein the identifier is a hash value, and data of each subgraph indicates the nodes and the edges in each subgraph; and
the calculating respective identifiers of the at least two subgraphs based on the nodes and the edges that are comprised in each subgraph of the at least two subgraphs, further cause the at least one processor to:
for each subgraph of the at least two subgraphs, calculate, based on hash values respectively corresponding to the plurality of nodes in each subgraph and hash values corresponding to the plurality of edges in each subgraph, a hash value corresponding to each subgraph.

17. The non-transitory computer-readable storage medium according to claim 16, wherein in each subgraph, a hash value corresponding to one node is related to an attribute of the node; and
in each subgraph, a hash value corresponding to one edge is related to a connection relationship indicated by the edge in each subgraph.

18. The non-transitory computer-readable storage medium according to claim 15, wherein the identifier is a hash value; and
the combining subgraphs with a same identifier in the at least two subgraphs, further cause the at least one processor to:
combine subgraphs with a same hash value in the at least two subgraphs;
add a first port and a second port of each first node in a plurality of first nodes, wherein each first node is a node whose outdegree or indegree is greater than a first threshold in the first graph, an edge indicating that data is input into each first node passes through the first port of each first node, and an edge indicating that data is output from each first node passes through the second port of each first node; and
perform the following operations on the plurality of first nodes to generate the second graph:
combine a plurality of edges that pass through one first port, and combining a plurality of edges that pass through one second port.

19. The non-transitory computer-readable storage medium according to claim 18, wherein the second graph is arranged in an orthogonal edge routing manner.

20. The non-transitory computer-readable storage medium according to claim 15, wherein the identifier is a hash value; and
the combining subgraphs with a same identifier in the at least two subgraphs, further cause the at least one processor to:
combine subgraphs with a same hash value in the at least two subgraphs;
add ports to a plurality of first edges and a plurality of second edges, wherein each first edge indicates an input of a scope, each second edge indicates an output of the scope, and the scope indicates a computational function based on a combination of one group of nodes and edges;
combine a plurality of third ports in the plurality of added ports, wherein the third port is a port on an edge that is in the plurality of first edges, that corresponds to one scope, and that indicates an input from a same node; and combining a plurality of fourth ports in the plurality of added ports, wherein the fourth port is a port on an edge that is in the plurality of second edges, that corresponds to one scope, and that indicates an output toward a same node; and
arrange the second graph in an orthogonal edge routing manner based on a combined port.
